(19) United States
(12) Patent Application Publication
(10) Pub. No.: US 2022/0153249 A1
(43) Pub. Date: May 19, 2022

(54) Braking System For Heavy Duty Vehicles And Related Methods

(71) Applicant: Continental Automotive Systems, Inc., Auburn Hills, MI (US)

(72) Inventor: Eric Matoy Matoy, Leonard, MI (US)

(73) Assignee: Continental Automotive Systems, Inc., Auburn Hills, MI (US)

(21) Appl. No.: 17/593,743

(22) PCT Filed: Apr. 8, 2020
(86) PCT No.: PCT/US2020/027217

§ 371 Date: Sep. 23, 2021

Related U.S. Application Data
(60) Provisional application No. 62/831,390, filed on Apr. 9, 2019.

(51) Int. Cl. B60T 13/14

(52) U.S. Cl. CPC B60T 13/146; B60T 2270/88

(57) ABSTRACT

A braking system for heavy duty vehicles includes a primary active brake booster module having a primary reservoir, a primary actuator, and a master cylinder, the primary brake booster operably coupled with a rear axle, the rear axle including rear wheels coupled therewith. The braking system further includes a secondary active brake booster module having a secondary reservoir and a secondary actuator, the secondary brake booster operably coupled with a front axle, the front axle including front wheels coupled therewith.

### CROSS-REFERENCE TO RELATED APPLICATIONS

The present application is a National Stage Application under 35 U.S.C. 371 of International Patent Application No. PCT/US2020/027217, which claims priority from U.S. Provisional Application No. 62/831,390 filed in the U.S. Patent and Trademark Office on Apr. 9, 2019, the disclosures of which are herein incorporated by reference in their entireties.

### BACKGROUND

### 1. Field

The disclosure herein relates to a braking system for heavy duty vehicles.

### 2. Description of Related Art

Larger vehicles such as trucks having a gross vehicle weight (GVW) of over 13,000 lbs. require unique braking solutions. Conventional braking systems use a primary braking system with a secondary braking module. The secondary braking module is not intended to be used at all times. Instead, the secondary breaking system is a redundant fallback system.

What is needed is a better way to provide a braking system for larger vehicles.

### BRIEF SUMMARY

A braking system for heavy duty vehicles includes a primary active brake booster module having a primary reservoir, a primary actuator, and a master cylinder, the primary brake booster operably coupled with a rear axle, the rear axle including rear wheels coupled therewith. The braking system further includes a secondary active brake booster module having a secondary reservoir and a secondary actuator, the secondary brake booster operably coupled with a front axle, the front axle including front wheels coupled therewith.

In one or more embodiments, the primary reservoir has three chambers.

In one or more embodiments, the secondary reservoir includes a single chamber.

In one or more embodiments, a braking system for heavy duty vehicles includes a primary active brake booster module having a primary reservoir, a primary actuator, and a master cylinder, the primary brake booster operably coupled with a front axle, the front axle including front wheels coupled therewith. The braking system further includes a secondary active brake booster module having a secondary reservoir and a secondary actuator, the secondary brake booster operably coupled with a rear axle, the rear axle including rear wheels coupled therewith.

In one or more embodiments, the primary reservoir has three chambers.

In one or more embodiments, the secondary reservoir includes a single chamber.

### BRIEF DESCRIPTION OF THE DRAWINGS

FIG. 1 illustrates a diagram of a braking system as constructed in accordance with one or more embodiments.

FIG. 2 illustrates a diagram of a braking system as constructed in accordance with one or more embodiments.

FIG. 3 illustrates a diagram of a braking system as constructed in accordance with one or more embodiments.

FIG. 4 illustrates a diagram of a braking system as constructed in accordance with one or more embodiments.

FIG. 5 illustrates a diagram of a braking system as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

A braking system 100 for heavy duty vehicles is described herein. Heavy duty vehicles are defined as trucks or vehicles having a gross vehicle weight greater than 13,000 lbs and typically include brake calipers of at least 60 mm for the front axle and at least 51 mm for the rear axle. The braking system 100 is a hydraulic boost braking system in which boosted fluid pressure is utilized to apply braking forces for the braking system 100.

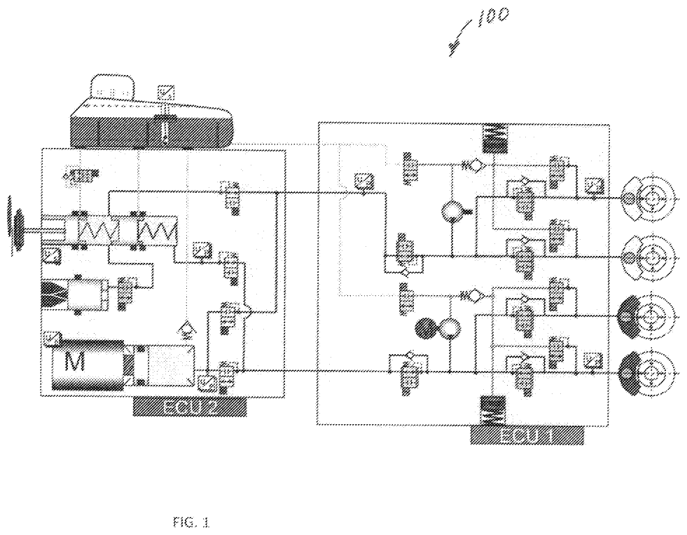

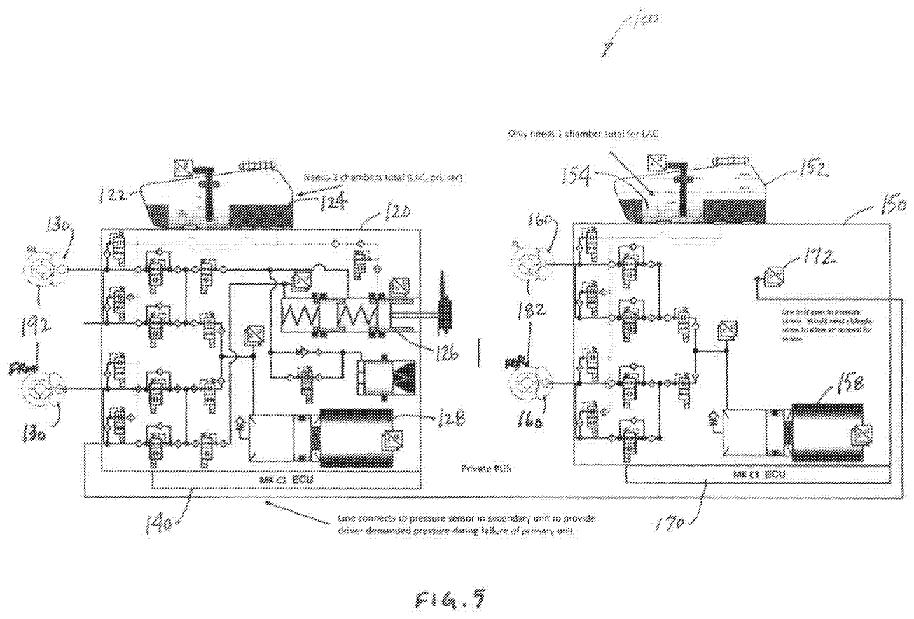

The braking system 100 includes two active braking modules where one is used for the front axle, and the other is used for the rear axle. The active braking modules are used continuously for the respective axles; the braking modules are not used redundantly. During operation, each braking module of the braking system is active for each of the axles. In one or more embodiments, the two active braking modules are used in the diagonal (one for FR, RL and one for FL, RR), as shown in FIG. 5. The active braking modules are used continuously for the different braking units and are not used redundantly. The various embodiments of the braking system 100 can be seen in FIGS. 1-5.

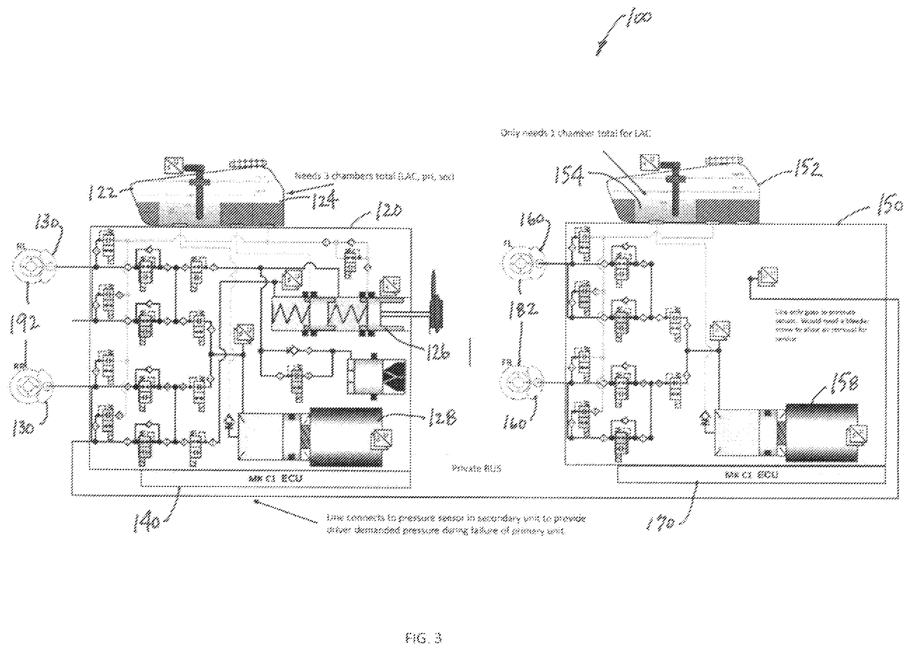

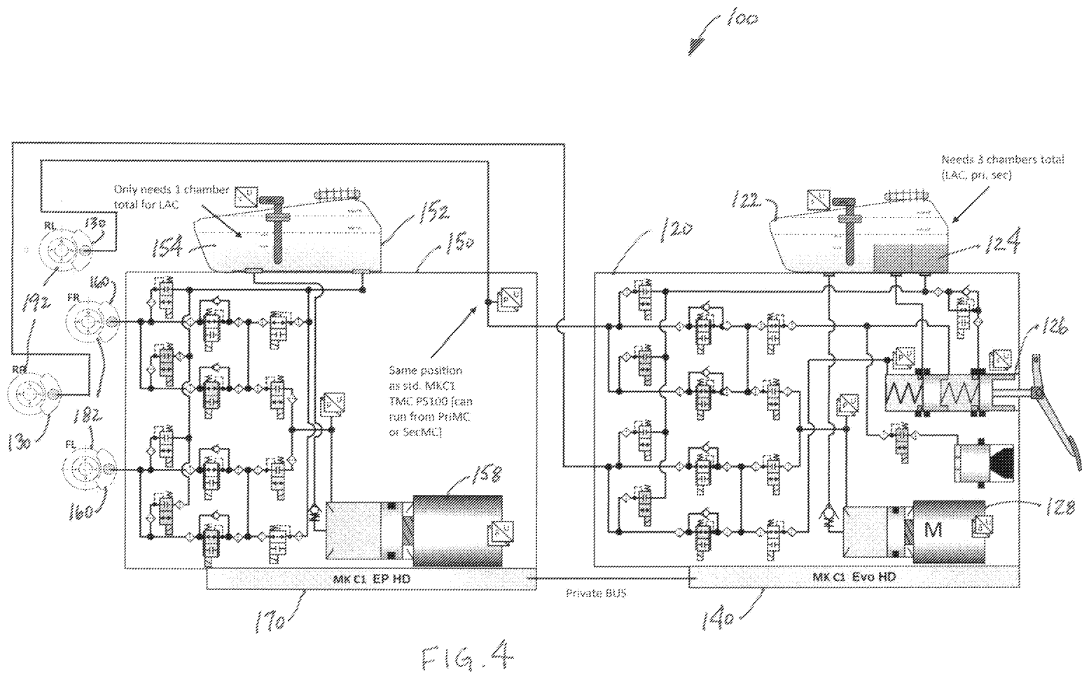

Referring to FIGS. 3, 4, and 5, a braking system 100 for heavy duty vehicles includes a primary active brake booster module 120 having a primary reservoir 122, a primary actuator 128, and a master cylinder 126. Regarding FIGS. 3 and 4, the primary active brake booster module 120 operably coupled with a rear axle, the rear axle including rear wheels 192 coupled therewith. The primary active brake booster module 120 further includes primary wheel brakes 130 that include wheel brake structure operated by the application of pressurized brake fluid. The primary wheel brakes 130 include, but are not limited to, a brake caliper that is used to engage a frictional element, such as a brake disc, that is connected to and rotates with a rear vehicle wheel to brake the rear vehicle wheel. Given the typical weight distribution for heavy duty vehicles, having the primary active brake booster module 120 on the rear axle allows for a higher level of deceleration with a single point failure.

The braking system 100 further includes a secondary active brake booster module 150 having a secondary reservoir 152 and a secondary actuator 158, the secondary active brake booster module 150 is operably coupled with a front axle, the front axle including front wheels 182 coupled therewith. The secondary active brake booster module 150 further includes secondary wheel brakes 160 that include wheel brake structure operated by the application of pressurized brake fluid. The secondary wheel brakes 160 include, but are not limited to, a brake caliper that is used to engage a frictional element, such as a brake disc, that is connected to and rotates with a front vehicle wheel to brake the front vehicle wheel. In one or more embodiments, the primary brake booster 120 and the secondary brake booster 150 are separate units and are not combined within one housing.

In one or more embodiments, a pressure sensor 172 is disposed in the secondary active brake booster module 150 which measures pressure coming from the primary active brake booster module 120. In one or more embodiments, the brakes are operated based on pressure sensed from the pressure sensor 172.

The primary and secondary reservoirs 122, 152 store and hold hydraulic fluid for the braking system 100. The fluid within the reservoirs 122, 152 can be held at atmospheric pressure, or other pressures. In one or more embodiments, the primary reservoir 122 has at least one chamber 124, and in one embodiment has three chambers. In one or more embodiments, the secondary reservoir 152 has at least one chamber, and in one embodiment includes a single chamber. The chambers can be separated by interior walls within the reservoirs.

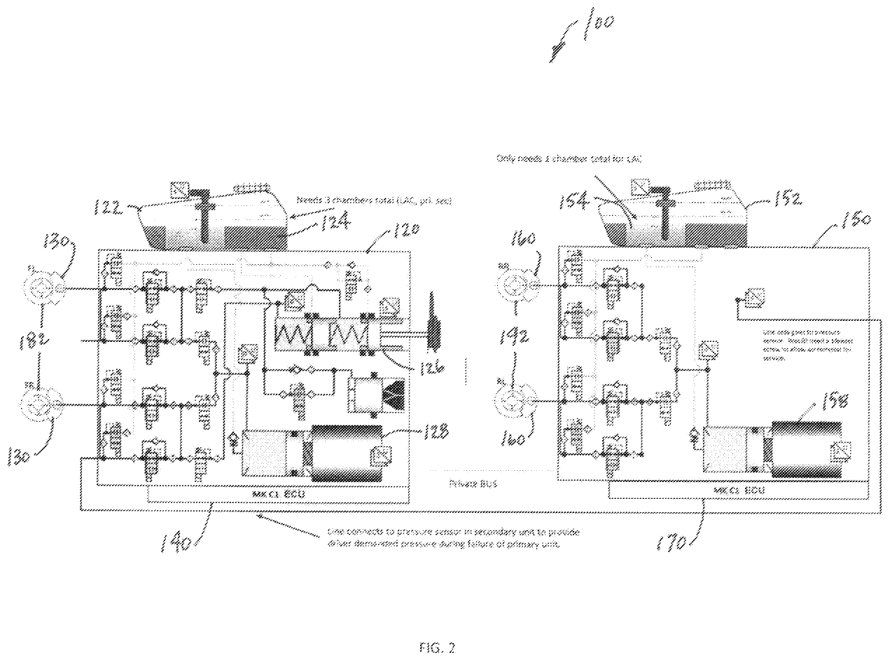

In one or more embodiments, as shown in FIG. 2, a braking system 100 for heavy duty vehicles includes a primary active brake booster module 120 having a primary reservoir 122, a primary actuator 128, and a master cylinder 126, the primary active brake booster module 120 operably coupled with a front axle, the front axle including front wheels 182 coupled therewith. The primary active brake booster module 120 further includes primary wheel brakes 130 that include wheel brake structure operated by the application of pressurized brake fluid. The primary wheel brakes 130 include, but are not limited to, a brake caliper that is used to engage a frictional element, such as a brake disc, that is connected to and rotates with a front vehicle wheel to brake the front vehicle wheel.

The braking system 100 further includes a secondary active brake booster module 150 having a secondary reservoir 152 and a secondary actuator 158, where the secondary primary brake booster module 150 is operably coupled with a rear axle, and the rear axle includes rear wheels 192 coupled therewith. The secondary active brake booster module 150 further includes secondary wheel brakes 160 that include wheel brake structure operated by the application of pressurized brake fluid. The secondary wheel brakes 160 include, but are not limited to, a brake caliper that is used to engage a frictional element, such as a brake disc, that is connected to and rotates with a rear vehicle wheel to brake the rear vehicle wheel.

In one or more embodiments, the primary reservoir 122 has at least one chamber 124, and in one embodiment has three chambers. In one or more embodiments, the secondary reservoir 152 has at least one chamber, and in one embodiment includes a single chamber. The primary and secondary reservoirs 122, 152 store and hold hydraulic fluid for the braking system 100. The fluid within the reservoirs 122, 152 can be held at atmospheric pressure, or other pressures. In one or more embodiments, the primary reservoir 122 has at least one chamber 124, and in one embodiment has three chambers. In one or more embodiments, the secondary reservoir 152 has at least one chamber, and in one embodiment includes a single chamber. The chambers can be separated by interior walls within the reservoirs.

The braking system 100 further includes a primary electronic control unit 140 (ECU) for the primary active brake booster module 120. The primary ECU 140 receives various signals, processes signals, and controls the operation of various electrical components in response to the received signals. The primary ECU 140 can be connected to various sensors including, but not limited to fluid level sensors, pressure sensors, and wheel speed sensors. The primary ECU 140 is optionally connected to an external module to receive additional information related to yaw rate, longitudinal acceleration, and lateral acceleration. The primary ECU 140 is further optionally connected to a display for supplying information related to warning indicators such as, but not limited to, a brake fluid level warning, ABS warning, or traction control.

The secondary active brake booster module 150 includes a secondary electronic control unit 170 (ECU). The secondary ECU 170 receives various signals, processes signals, and controls the operation of various electrical components in response to the received signals. The secondary ECU 170 can be connected to various sensors including, but not limited to fluid level sensors, pressure sensors, and wheel speed sensors. The secondary ECU 170 is optionally connected to an external module to receive additional information related to yaw rate, longitudinal acceleration, and lateral acceleration. The secondary ECU 170 is further optionally connected to a display for supplying information related to warning indicators such as, but not limited to, a brake fluid level warning, ABS warning, or traction control.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A braking system comprising:
a primary active brake booster module comprising a primary reservoir, a primary actuator, and a master cylinder, the primary brake booster configured to be coupled with a rear axle of a vehicle; and
a secondary active brake booster module comprising a secondary reservoir and a secondary actuator, the secondary brake booster configured to be coupled with a front axle of the vehicle.

2. The braking system recited in claim 1, wherein the primary reservoir includes three chambers.

3. The braking system as recited in claim 1, wherein the secondary reservoir includes a single chamber.

4. The braking system as recited in claim 1, wherein the secondary active brake booster module comprises configured to sense pressure coming from the primary active brake booster module.

5. The braking system as recited in claim 4, further comprising brakes configured to operate based on the pressure sensed by the pressure sensor.

6. A braking system comprising:
a primary active brake booster module comprising a primary reservoir, a primary actuator, and a master cylinder, the primary brake booster configured to be coupled with a front axle of a vehicle; and
a secondary active brake booster module comprising a secondary reservoir and a secondary actuator, the secondary brake booster configured to be coupled with a rear axle of the vehicle.

7. The braking system as recited in claim 6, wherein the primary reservoir has includes three chambers.

8. The braking system as recited in claim 6, wherein the secondary reservoir includes a single chamber.

9. A braking system comprising:
a primary active brake booster module comprising a primary reservoir, a primary actuator, and a master cylinder, the primary brake booster configured to be coupled with a front right wheel and a rear left wheel of a vehicle; and
a secondary active brake booster module comprising a secondary reservoir and a secondary actuator, the secondary brake booster configured to be coupled with a front left wheel and a rear right wheel of the vehicle.

10. The braking system as recited in claim 9, wherein the primary reservoir includes three chambers.

11. The braking system as recited in claim 9, wherein the secondary reservoir includes a single chamber.
